(19) United States
(12) Patent Application Publication
(10) Pub. No.: US 2026/0042158 A1
(43) Pub. Date: Feb. 12, 2026

(54) Hand-held circular saw

(71) Applicant: Festool GmbH, Wendlingen am Neckar (DE)

(72) Inventors: Andreas Randecker, Dettingen (DE); Wolfgang Spengler, Neidlingen (DE); Dominic Ender, Reudern (DE); José Gabriel Kunze, Tübingen (DE); Charlotte Schleifenbaum, Rechberghausen (DE)

(21) Appl. No.: 18/998,160

(22) PCT Filed: Jul. 27, 2023
(86) PCT No.: PCT/EP2023/070850

§ 371 Date: Jan. 24, 2025

(30) Foreign Application Priority Data
Jul. 29, 2022 (EP) 22187853.1

(51) Int. Cl. B23D 59/00; B23D 45/16; B27B 9/02; B27G 19/04

(52) U.S. Cl. CPC B23D 59/003; B23D 45/16; B23D 59/0064; B27B 9/02; B27G 19/04

(57) ABSTRACT

The invention relates to a hand-held circular saw (10) having a saw blade holder (33), which is arranged for mounting a saw blade (30) and which can be rotated about a drive axis (34) by means of a drive assembly (20), wherein a protective cover (24) is provided, which encompasses a chip-guiding space (24.11), inside which a saw-blade-mounting area (24.12) is formed, which is disposed and designed to hold the saw blade (30) in a working position, wherein the protective cover (24) has a lateral casing (24.6), which delimits the chip-guiding space (24.11) at the end facing away from the drive assembly (20), wherein an illumination arrangement (70) having at least one illumination element (71) is provided to at least sectionally illuminate the cutting area of the hand-held circular saw (10), and wherein the illumination element (71) is disposed behind the saw-blade-mounting area (24.12) and/or the cutting area in the feed direction (V) of the hand-held circular saw (10). For improved operating comfort, according to the invention provision is made for the illumination arrangement (70) to be disposed and oriented in such a way that the light emitted by the illumination element (71) is predominantly emitted in the feed direction (V) of the hand-held circular saw (10), in particular without glare for a user of the hand-held circular saw (10), and for the light emitted by the illumination element (71) to extend at least sectionally, preferably completely, in a light-guiding area (24.13), which is separated from the dust-conveying area of the chip-guiding chamber (24.11).

The invention relates to a hand-held circular saw having a saw-blade holder, which is arranged for mounting a saw blade and which can be rotated about a drive axis by means of a drive assembly, wherein a protective cover is provided, which encompasses a chip-guiding space, inside which a saw-blade-mounting area is formed, which is disposed and designed to receive the saw blade in a working position, wherein the protective cover has a lateral casing, which delimits the chip-guiding space at the end facing away from the drive assembly, wherein an illumination arrangement having at least one illumination element is provided to at least sectionally illuminate a cutting area of the hand-held circular saw, and wherein the illumination element is disposed behind the saw-blade-mounting area and/or the cutting area in the feed direction of the hand-held circular saw.

JP2022-46093 discloses a hand-held circular saw having a protective cover encompassing a chip-guiding space. A saw blade is held in the chip-guiding space. An illumination arrangement is disposed behind the saw blade in the feed direction in the chip-removal area. The illumination arrangement emits its light transverse to the axis of rotation of the saw blade on both sides of the saw blade. In that way, the saw blade, which is in the light path of the illumination arrangement, casts a shadow on the workpiece to be processed.

The invention addresses the problem of providing a hand-held circular saw of the type mentioned at the beginning, which makes for improved ease of use in conjunction with high operational safety.

This problem is solved in that the illumination arrangement is disposed and oriented in such a way that the light emitted by the illumination element is predominantly emitted in the feed direction of the hand-held circular saw, and in that the light emitted by the illumination element extends at least sectionally, preferably completely, in a light-guiding area, which is separated from the dust-conveying area of the chip-guiding space.

Because the illumination element is disposed behind the saw-blade-mounting area and/or the cutting area in the feed direction and therefore behind the saw blade, the entire working area of the saw blade can be illuminated as required by the user. The illumination is further improved because the light emitted by the illumination element is predominantly emitted in the feed direction of the hand-held circular saw. This increases ease of use even in awkward working positions. The fact that the light emitted by the illumination element extends at least sectionally, preferably completely, in a light-guiding area that is separate from the dust-conveying area means that the light path is not influenced by the chips separated from the workpiece during machining operation. This means that the working area, in particular the cutting area, can be illuminated safely and without glare for the user of the hand-held circular saw, even during machining.

Preferably, the illumination element is disposed separately from the dust-conveying area of the chip-guiding space guide chamber such that it does not become soiled.

According to one variant of the invention, provision may be made for the illumination element to illuminate the cutting area of the hand-held circular saw on the outside of the casing. The cutting area shall be defined as the area, in which the saw blade cuts a surface of the workpiece to be machined when the hand-held circular saw is in contact with the workpiece. Preferably, provision is made for the cutting area on the outside of the casing to be illuminated where the saw blade cuts into the workpiece. For instance, a positioning device can be provided that enables the illumination element to be focused on this area.

Preferably, provision may be made for the protective cover to have a rear area marking on its outer face facing away from the chip-guiding space to identify the rear end of the cutting area in the feed direction and a front area marking to identify the front end of the cutting area in the feed direction, and for the light emitted by the illumination element to illuminate at least a partial area, preferably at least the entire area, between the two area markings.

A hand-held circular saw according to the invention can be designed such that a lamp support is provided, which keeps the illumination element in the area of the outer face facing away from the chip-guiding space. There, the illumination element is accommodated in a manner that is easily accessible for the user, on the one hand. On the other hand, it can effectively illuminate the working area of the hand-held circular saw.

If provision is made for the lamp support to have a locating arrangement to which the illumination arrangement is interchangeably coupled, then a user can make the illumination arrangement suitably accessible if necessary. When it is no longer needed, it can be dismantled and set aside.

Preferably, provision may be made for the illumination element to be held in the area of the lateral casing of the protective cover, particularly preferably to be attached to the lateral casing. Preferably, the illumination element is then removably connected to the protective cover. In particular, it does not affect sawing close to a wall in the area of the outer face of the protective cover.

It is preferable for the illumination element to be directly or indirectly connected to the hand-held circular saw via an interface in a swiveling manner. This allows the light beam of the illumination element to be suitably adjusted. For this purpose, provision may be made in particular for the lamp support to have a bearing element, which is coupled to a support piece, in particular to the protective cover, of the hand-held circular saw by means of a securing piece, for a counter-bearing element to be movably connected to the bearing element, for the illumination arrangement to be coupled, preferably detachably, to the counter-bearing element, and for the bearing element and the counter-bearing element to form an adjustable bearing for moving the position of the illumination arrangement.

For a suitable focusing of the illumination arrangement, it is advantageous if provision is made for the illumination arrangement to be movable, in particular swiveling, by at least one rotational degree of freedom relative to the support piece of the hand-held circular saw, in particular relative to the protective cover. However, it is also conceivable, additionally or alternatively, that an actuating arrangement is provided, which can be used to move the illumination arrangement in a translatory manner, in particular to achieve a suitable assignment to the protective cover.

For a space-saving positioning of the illumination arrangement, provision may be made for the protective cover to have a suction connection having a connection fitting behind the saw-blade-mounting area in the feed direction, for a connection arrangement to be attached, preferably interchangeably, to the connection fitting, and for the connection arrangement to have a connecting element, to which the lamp support is attached, preferably interchangeably.

To reduce the amount of parts required, provision may be made for the connection arrangement to have a duct section for chip removal, for the duct section to bear the connecting element, to which a support is connected spaced apart from the duct section, and for the support to have an attachment mount for coupling to the lamp support.

A particularly preferred variant of the invention provides that the drive assembly is swivel-coupled to a guide plate by means of a rear miter bearing, which is disposed behind the saw-blade-mounting area in the feed direction to swivel the drive assembly relative to the guide plate for setting a miter angle, that the miter bearing comprises a stationary and a movable bearing piece, wherein the stationary bearing piece is coupled to the guide plate and the movable bearing piece is coupled to the drive assembly, and that the illumination element is attached either to the stationary or to the movable bearing piece. There, the illumination element is suitably positioned to emit the light largely or completely in the feed direction. In addition, there the illumination element is accommodated in a space-saving manner and it does not affect the motion range of the hand-held circular saw, or only insignificantly.

Some hand-held circular saws are designed in such a way that their protective cover has a limiting element on its underside facing the workpiece, which limiting element is angled towards the cutting area. One design variant of the invention makes use of a protective cover designed in such a way, wherein the illumination element is disposed in such a way that it emits its light in the feed direction along the limiting element. This allows the light to be brought very close to the actual position of the saw blade, thereby improving working precision.

If provision is made for the illumination arrangement to have a lamp housing, which accommodates the illumination element, for the lamp housing to have or bear a fastening section, by means of which it is interchangeably attached to a lamp support, wherein preferably provision is made for the lamp support to be disposed on the outer face of the protective cover facing away from the chip-guiding space, preferably on the outer face of the lateral casing facing away from the chip-guiding space, then the user can easily attach the lamp housing to the hand-held circular saw or remove it therefrom. In addition, the user can use the illumination arrangement separately in the form of a flashlight.

The installation of such an illumination arrangement is particularly easy if provision is made for the lamp housing to be interchangeably connected to the lamp support by means of a magnetic connection. If also provision is made for the lamp housing to have a form-fitting element to form a form-fitting connection between the lamp housing and the lamp support that acts transversely to the magnetic force, then the positioning of the lamp housing can be reliably maintained via the form-fitting connection, even under external mechanical stresses such as vibrations.

A particularly preferred variant of the invention provides that the protective cover separates the ferrous part of the magnetic connection from the magnetic part of the magnetic connection. In that case, the magnetic part (or the ferrous part) can be held on the inner face of the protective cover (or integrated into the protective cover itself) facing the chip-guiding duct, protected from view. This means that the magnetic part (or the ferrous part) is not visually disruptive.

To avoid or prevent the risk of injury when the illumination element is activated, according to one variant of the invention provision is made for the lamp housing to bear an electrical switch in its area facing away from the guide plate of the hand-held circular saw.

For optimum positioning of the illumination element, the lamp housing can be designed to hold the illumination element in its end area facing the guide plate in the area of the free end of the lateral casing and laterally next to the lateral casing.

A possible variant of the invention can be such that a cover is disposed inside the chip-guiding space, which cover separates the light-guiding area from the dust-conveying area of the chip-guiding space at least sectionally, wherein preferably provision is made for the illumination element to be disposed outside the chip-guiding space or for the cover or a further cover element to separate an area in the chip-guiding space, inside which the illumination element is disposed such that it is disposed separately from the dust-conveying area. To this end, the illumination element is integrated behind the protective cover to save space, although it is separated from the chip-guiding duct to prevent any soiling of the illumination element and/or interference with the light path.

To achieve suitable illumination in the area outside of the protective cover in such an arrangement, provision may be made for the protective cover, in particular the lateral casing, to have a light passage, through which the light of the illumination element is guided and routed out of the chip-guiding space. Preferably, provision may be made for the light passage to be provided at least sectionally on a/the limiting element, which is formed at the lower free end of the lateral casing in the form of a bend directed inwards towards the chip-guiding space to be able to illuminate the vicinity of the cutting area of the saw blade.

One conceivable alternative solution of the invention is designed in such a way that the protective cover, in particular the lateral casing, has at least one attachment mount, to which the illumination arrangement is attached, wherein the attachment mount is formed as an aperture in the protective cover or as a recess in the protective cover. In this way, the illumination arrangement can be installed in a space-saving manner.

The invention is explained in greater detail below based on exemplary embodiments shown in the drawings. In the figures,

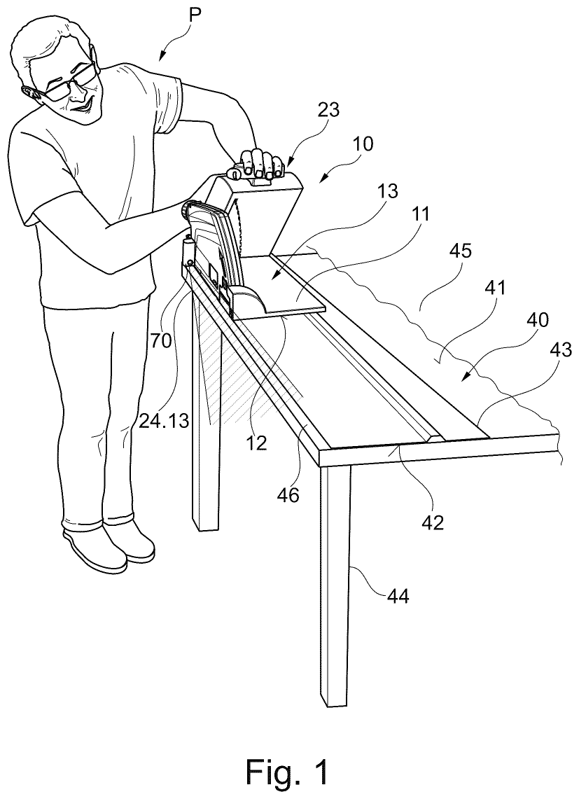

FIG. 1 shows a typical work situation, in which a user guides a hand-held circular saw along a guide rail to cut a workpiece,

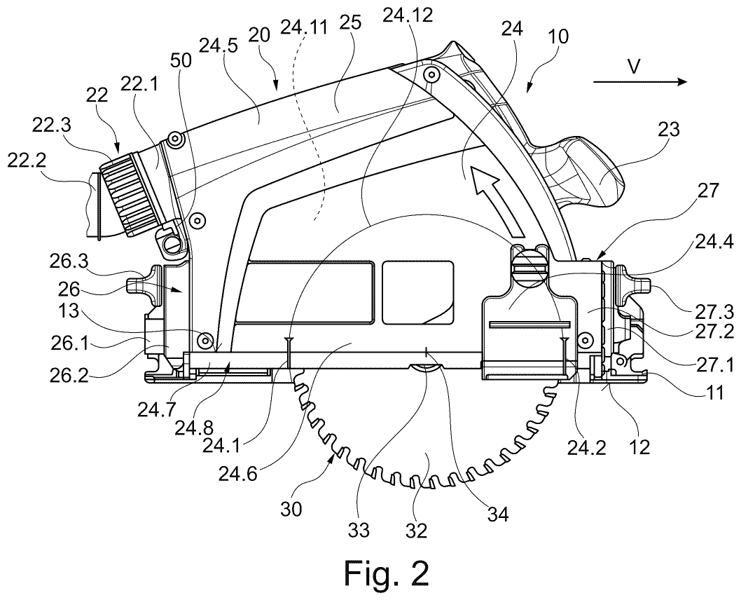

FIG. 2 shows a side view of a hand-held circular saw according to the invention,

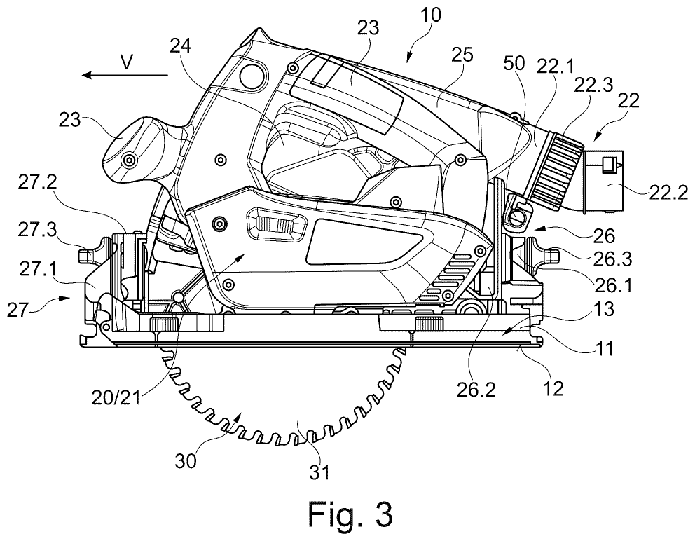

FIG. 3 shows the hand-held circular saw of FIG. 2, viewed from the opposite end of FIG. 2,

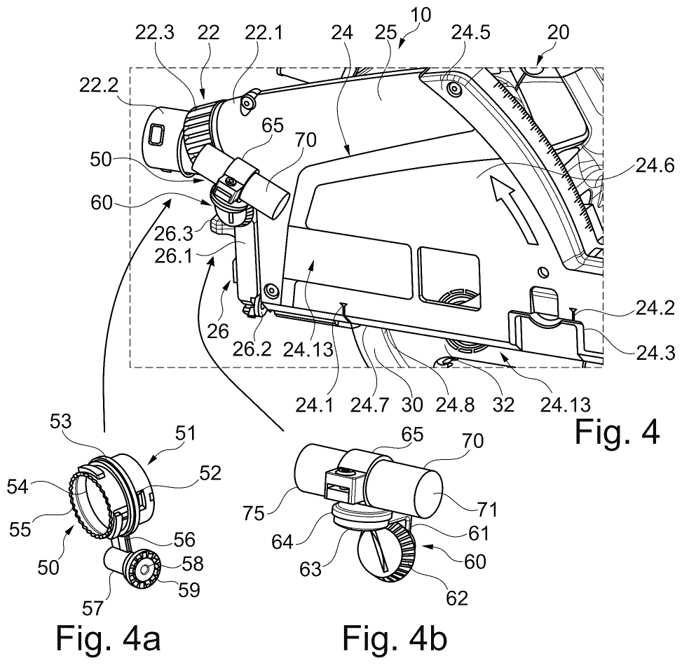

FIG. 4 shows a detailed illustration of a hand-held circular saw according to the invention with an illumination arrangement attached thereto,

FIG. 4A shows an isolated representation and a perspective view of a connection arrangement of the hand-held circular saw of FIG. 4,

FIG. 4B shows an isolated representation and a perspective view of an illumination arrangement mounted on a lamp support,

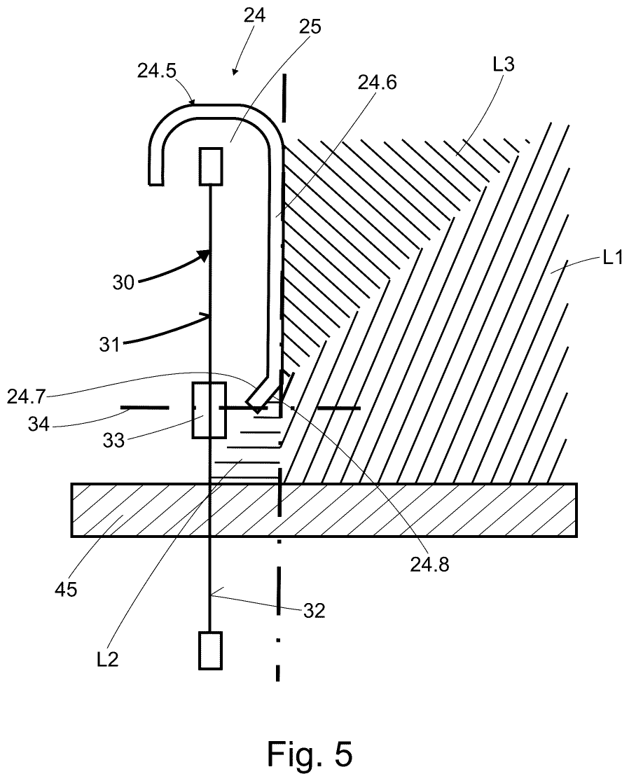

FIG. 5 shows a symbolic view of various illumination areas assigned to a protective cover of the hand-held circular saw,

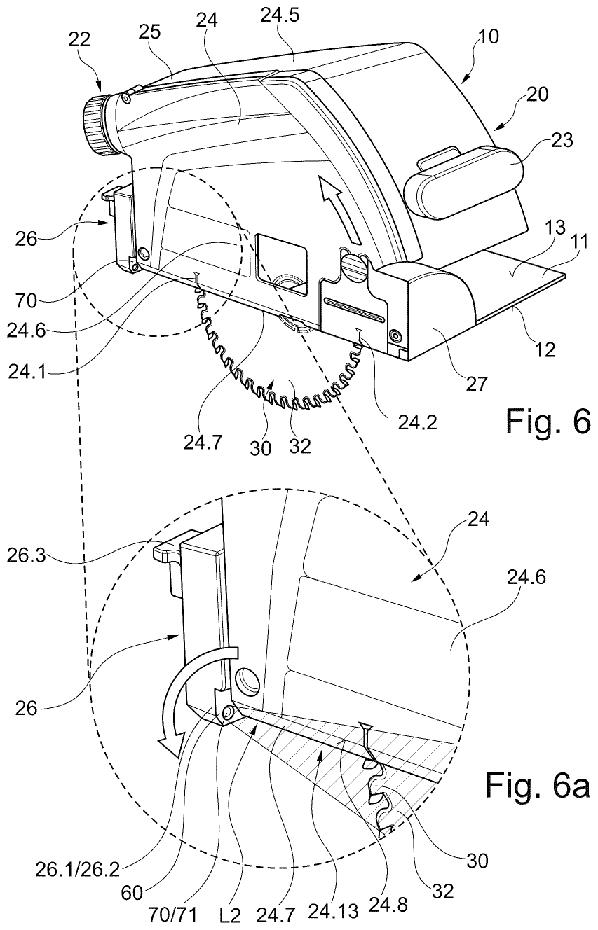

FIG. 6 shows a perspective side view of an alternative design variant of a hand-held circular saw,

FIG. 6A shows a detailed representation taken from FIG. 6,

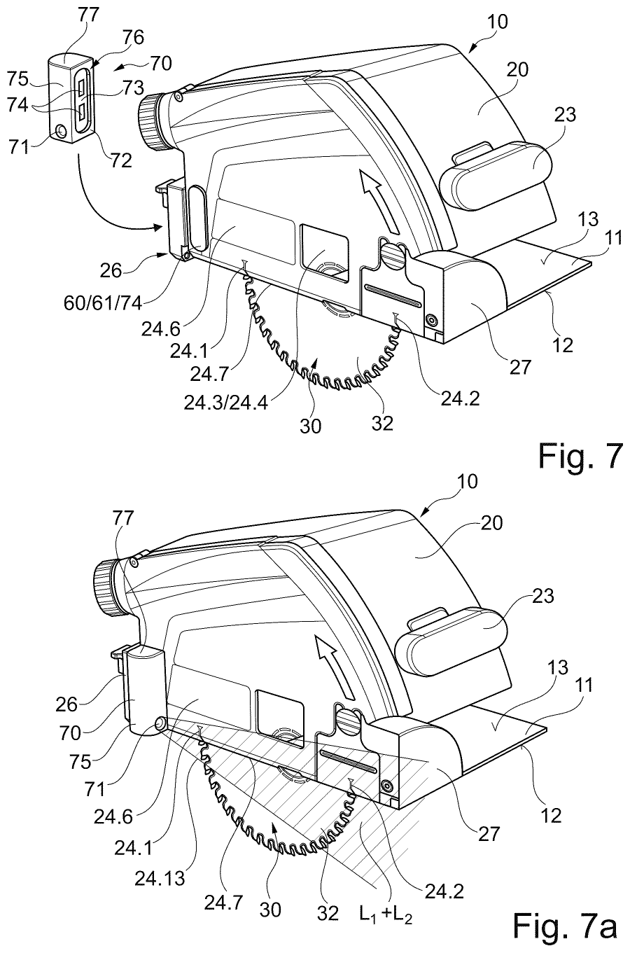

FIG. 7 shows a perspective side view and an exploded view of a further alternative solution of the invention of a hand-held circular saw,

FIG. 7A shows the representation of FIG. 7 in the assembled state,

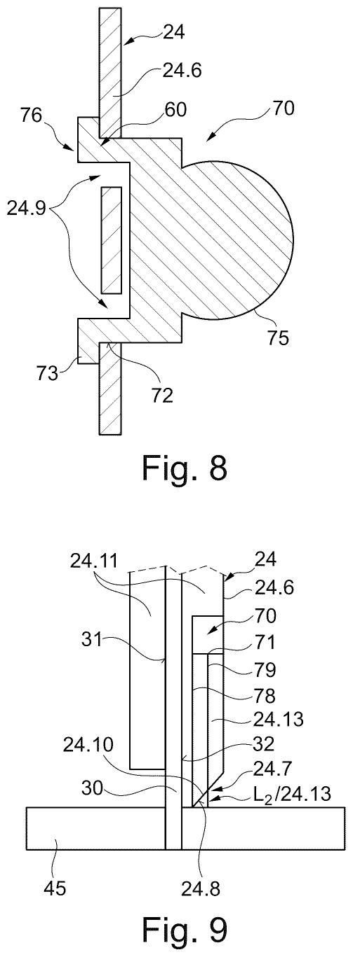

FIG. 8 shows a detailed schematic representation of a further alternative solution of the invention,

FIG. 9 shows a schematic representation of a further alternative solution of the invention.

FIG. 1 shows a typical work situation in which an operator P processes a workpiece 45 lying on a work table 44 using a hand-held circular saw 10. The hand-held circular saw 10 is used to cut off a section 46 of the workpiece 45. For this operation, the rail underside 42 of a guide rail 40 is placed on the top face of the workpiece 45. The hand-held circular saw 10 is placed on the top face 41 of the guide rail 40. The hand-held circular saw 10 can be guided in the longitudinal direction of the rail on a guide element 43 of the guide rail 40 in the known manner.

In accordance with the invention, an illumination arrangement 70 is mounted on the hand-held circular saw 10, which illumination arrangement can be used to direct light onto the top face of the workpiece via a light-guiding area 24.13.

FIGS. 2 and 3 show the technical design of the hand-held circular saw 10. As these representations show, the hand-held circular saw 10 has a guide plate 11, which can be used to place the former on the guide rail 40. On its downward-facing support end 12, the hand-held circular saw 10 has a guide mount that interacts with the guide element 43 of the guide rail 40 for longitudinal guidance. In the area of its top face 13, the guide plate 11 has a retaining structure, which can be used to connect a drive assembly 20 to the guide plate 11.

The drive assembly 20 has a drive motor 21, which can be used to rotate a saw blade holder 33. A saw blade 30 can be interchangeably attached to the saw blade holder 33. FIG. 2 illustrates the position of the drive axis 34 about which the saw blade 30 can be rotated. On its side facing the drive motor 21, the saw blade 30 has an inner saw blade face 31 and an outer saw blade face 32 on the opposite side, which can be seen in FIG. 2. The inner saw blade face 31 is illustrated in FIG. 3.

When mounted, the saw blade 30 is accommodated in a saw-blade-mounting area 24.12 of a protective cover 24. This hand-held circular saw 10 is a plunge-cut saw, in which the drive assembly 20 and the saw blade 30 can be swiveled about a swivel axis extending perpendicular to the image plane as shown in FIGS. 2 and 3 to swivel the saw blade 30 at least partially out of the protective cover 24 into a plunge-cut position. Such a plunge-cut position with the saw blade 30 swiveled to the maximum is shown in FIGS. 2 and 3.

The protective cover 24 may have a connection fitting 22.1, which is preferably integrally connected to the protective cover 24. The connection fitting 22 serves as suction connection 22. A coupling piece 22.1 can be detachably attached to the suction connection 22 by means of a locking element 22.3. The coupling piece 22.2 can be part of a suction hose of a chip extraction system or be a connection piece for such a suction hose. During machining, the chip extraction system is used to extract chips from a chip-guiding duct 25 encompassed by the protective cover 24, which chip-guiding duct is spatially connected to the chip-guiding space 24.11.

As FIG. 2 illustrates, the protective cover 24 can form a lateral casing 24.6, which delimits the chip-guiding space 24.11 at the end facing away from the drive assembly 20. In other words, the lateral casing 24.6 delimits the chip-guiding space 24.11 in the area of the outer saw blade face 32.

The lateral casing 24.6 extends essentially perpendicular to the drive axis 34.

At its lower end, the lateral casing 24.6 can have a strip-shaped limiting element 24.7. The limiting element 24.7 forms an outer limiting surface 24.8, which is angled inwards towards the saw blade 30.

FIG. 2 further shows that the lateral casing 24.6 bears two markings, namely a rear area marking 24.1 and a front area marking 24.2. The cutting area of the saw blade 30 is marked between the two area markings 24.1 and 24.2 for the user P to be able to recognize it. The two range markings 24.1 and 24.2 thus illustrate the rear and front saw blade limits in the maximum plunge-cut position of the saw blade 30.

As FIG. 4 illustrates, there may be a recess 24.3 in the front cutting area of the saw blade 30 in the lateral casing 24.6, through which it is possible to view the front cutting area of the saw blade 30. The recess 24.3 can be covered with a detachable and transparent window 24.4. This window 24.4 may bear the front area marking 24.2.

For instance, the transparent window 24.4 may separate a light-guiding area 24.13 from the dust-conveying area of the chip-guiding space 24.11, wherein preferably provision is made for an illumination element 71 to be disposed outside the chip-guiding space 24.11 in such a way that it is disposed separately from the dust-conveying area, in particular separated from the chip-guiding space 24.11 by the transparent window 24.4.

The transparent window 24.4 thus forms a light passage 24.10 in the protective cover 24, in particular in the lateral casing 24.6, through which the light of the illumination element 71 is guided, wherein preferably provision is made for the light passage 24.10 to be provided at the limiting element 24.7, which is formed at the lower free end of the lateral casing 24.6 or of the transparent window 24.4 in the form of a bend directed inwards in the direction of the chip-guiding space 24.11.

FIG. 4 further illustrates that the protective cover 24 may have an upper cover area 24.5, which forms the above-mentioned chip-guiding duct 25.

FIGS. 2 and 3 further illustrate that the drive assembly 20 can be swivel connected to the guide plate 11 to permit miter cuts. For this purpose, the drive assembly 20 is connected to the guide plate 11 by means of a rear miter bearing 26 and a front miter bearing 27.

The rear miter bearing 26 has a fixed bearing piece 26.1, which is connected to the guide plate 11. A movable bearing piece 26.2 is connected to the fixed bearing piece 26.1 by means of a swivel bearing, wherein the movable bearing piece 26.2 is coupled to the drive assembly 20.

The front miter bearing 27 is designed in the same way and has a fixed bearing piece 27.1 and a movable bearing piece 27.2. To lock the set swivel position, the two miter bearings 26 and 27 each have a locking device 26.3, 27.3.

The setting and guidance of the hand-held circular saw 10 is facilitated by means of a handle 23 of the drive assembly 20, wherein the handle 23 can also have the trigger for activating the drive motor 21 in the usual manner.

FIGS. 4-4b illustrate that an illumination arrangement 70 can be interchangeably connected to the hand-held circular saw 10.

The illumination arrangement 70 has an illumination element 71, which is accommodated in a lamp housing 75.

The illumination arrangement 70 can be interchangeably connected to the hand-held circular saw 10. A connection arrangement 50 is used to attach the illumination arrangement 70. The connection arrangement 50 is connected to the hand-held circular saw 10. A lamp support 60 can be interchangeably attached to the connection arrangement 50. The lamp support 60 may have a further interface, to which the lamp housing 75 is interchangeably attached.

In the exemplary embodiment shown, the connection arrangement 50 has a support 57, which has an attachment mount 58. A fastening element 62 can be used to attach a securing piece 61 of the lamp support 60 to the support 57. As shown in the drawings, the fastening element 62 can have a screw that is screwed into the attachment mount 58.

A swivel bearing, a pivot bearing, a linear guide or a combination of a swivel or pivot bearing having a linear guide can be provided to permit the lamp support 60 to be moved relative to the connection arrangement 50.

In this exemplary embodiment, a swivel bearing is used, wherein the swivel axis being formed by the central longitudinal axis of the fastening element 62, which is designed as a fastening screw. Preferably, as shown in FIGS. 4a and 4b, the lamp support 60 can be moved in a latched manner relative to the connection arrangement 50. For this purpose, provision may be made for the connection arrangement 50 to have detents 59. A mating detent element of the lamp support 60 engages with the detent 59 to enable the detent motion.

FIG. 4b further illustrates that the lamp support 60 may also have a bearing element 63, which is swivel-coupled to a counter-bearing element 64. The counter-bearing element 64 supports the lamp housing 75 directly or indirectly and is used to set the illumination arrangement 70 in a swiveling manner. As shown in FIGS. 4a and 4b, according to a variant of the invention, provision may be made for the illumination arrangement 70 to be moved about two swivel axes (two rotational degrees of freedom) to suitably focus the light emitted by the illumination arrangement 70.

A locating arrangement 65 is used to secure the illumination arrangement 70. Preferably, the locating arrangement 65 is attached to the counter-bearing element 64 and is designed to establish a detachable connection with the lamp housing 75. In this exemplary embodiment, the locating arrangement 65 forms a gripper clamp.

In one variant of the invention, the connection arrangement 50 may form a duct section 51. This duct section 51 can be detachably connected to the connection fitting 22.1, as illustrated in FIG. 4a. For instance, the locking element 22.3 can be used to connect the duct section 51 to the connection fitting 22.1.

The duct section 51 has a plug attachment 52, which can be inserted into the connection fitting 22.1. A stop 53 of the duct section 51 limits his insertion motion. A neck 54 is provided at the end of the stop 53 opposite from the plug-in attachment 52, which neck can be used to connect the coupling piece 22.2.

The connection arrangement 50 has a form-fitting element, which interacts with a mating form-fitting element of the coupling piece 22.2 to secure the coupling piece 22.2 to the connection fitting 22.1 against rotation. For instance, the form-fitting element can be designed in the form of a toothing 55, which is inserted into the end face of the neck 54.

FIG. 4a further illustrates that the connection arrangement 50 bears a connecting element 56, to which the support 57 is attached, preferably integrally formed. The connecting element 56 may be integrally formed on the stop 53.

To mount the illumination arrangement 70, the connection arrangement 50 is attached to the hand-held circular saw 10 as described above. The fastening element 62 can then be used to attach the lamp support 60 to the support 57 of the connection arrangement 50. The illumination arrangement 70 is attached by means of the locating arrangement 65. The user P can then swivel the illumination arrangement 70 to direct the light cone generated by the illumination arrangement 70 to illuminate the sawing area.

As the illustrations show, the illumination arrangement 70 is disposed behind the saw blade 30 in the feed direction of the hand-held circular saw 10. The light emitted by the illumination arrangement 70 is essentially directed in the feed direction V, such that it at least partially illuminates the sawing area between the two area markings 24.1 and 24.2. In particular, the user P can adjust the illumination arrangement 70 such that the area around the front area marker 24.2 is sufficiently illuminated.

FIG. 5 illustrates a section through the protective cover 24 perpendicular to the support end 12 of the guide plate 11 and through the drive axis 34.

As this representation illustrates, different illumination areas L1, L2, L3 can be formed depending on the arrangement of the illumination arrangement 70 in relation to the lateral casing 24.6. The illumination areas L1 and L2 are particularly suitable and in accordance with the invention. The illumination area L1 is limited by the lateral casing 24.6 and the surface of the workpiece 45 to be processed. The illumination area L2 is limited by the workpiece surface and the limiting surface 24.8 of the limiting element 24.7 and extends up to or almost up to the end of the saw-blade-mounting area 24.12 facing the lateral casing 24.6 or up to the outer saw blade face 32.

The illumination area L3 is less suitable as it does not illuminate the workpiece surface in the cutting area.

The embodiment shown in FIGS. 4 to 4b can mainly be used to illuminate the illumination areas L1.

FIGS. 6 and 6a show an exemplary embodiment, which is used to illuminate in particular the illumination area L2 and partially the illumination area L1. Identical components are marked with the same reference numerals in these drawings, i.e., reference is made to the above explanations to avoid repetition.

As the illustrations show, the illumination arrangement 70 is connected to a part of the rear miter bearing 26. Preferably, the illumination arrangement 70 is connected to the movable bearing piece 26.2 such that it is swiveled with the protective cover 24 when the miter angle of the hand-held circular saw 10 is set.

The figures illustrate that the illumination arrangement 70 is disposed, preferably at least partially, inside the area formed by the extension of the lateral casing 24.6 and the limiting surface 24.8 of the limiting element 24.7. The illuminating element 71 emits its light in the feed direction V or essentially in the feed direction V to illuminate the illumination area L2 and possibly also partially the illumination area L1.

FIGS. 7 and 7a show a further variant of the invention. FIGS. 7 and 7a show an exemplary embodiment, which is used in particular to illuminate the illumination areas L1 and L2. Identical components are marked with the same reference numerals in these drawings, i.e., reference is made to the above explanations to avoid repetition.

As the drawings illustrate, an illumination arrangement 70 can be interchangeably connected to the protective cover 24, preferably to the lateral casing 24.6 of the protective cover 24. For this purpose, the illumination arrangement 70 has a fastening section 76, which can be interchangeably connected to the protective cover 24.

The illumination arrangement 70 has a lamp housing 75, in which an illumination element 71 is accommodated. Furthermore, a power supply, in particular a rechargeable battery, may be disposed in the lamp housing 75 to supply the illumination element 71 with power.

The lamp housing 75 has a contact surface 72 in the area of a mounting end, which is disposed and designed to be placed against the outer face of the lateral casing 24.6. A form-fitting element 73 may be present in the area of the contact surface 72, which form-fitting element comes into contact with a mating form-fitting element of the protective cover 24 to block a displacement of the lamp housing 75 in the plane of the outer face of the lateral casing 24.6. The form-fitting element 73 may be designed as a recess that is recessed into the contact surface 72. The mating form-fitting element can be formed by an elevation that protrudes beyond the outer face of the lateral casing 24.6.

A magnetic connection can be used to connect the illumination arrangement 70 to the protective cover 24. For instance, the lamp housing 75 may include a magnet 74 (or ferrous part), which interacts with a ferrous part (or magnet) of the protective cover 24 to form the magnetic connection.

In this exemplary embodiment, the ferrous part (or the magnet 74) is applied to the outer face of the lateral casing 24.6 and preferably also forms the mating form-fitting element at the same time. However, it is also conceivable that the ferrous part (or the magnet 74) is at least partially integrated into the material of the lateral casing 24.6 or is disposed on the inner face of the lateral casing 24.6 facing away from the outer face of the lateral casing 24.6.

The lamp housing 75 forms a cover section on its top face, which cover section is used with a switch 77 to switch the illumination element 71 on or off.

Preferably, when the illumination arrangement 70 is mounted, the lamp housing 75 bears the illumination element 71 at its end facing the guide plate 11. Particularly preferably, the lamp housing 75 holds the illumination element 71 in the area of the limiting surface 24.8 such that the illumination area L2 can also be at least partially illuminated, as illustrated in FIG. 7a, where the light-guiding area 24.13 is shown symbolically. This drawing also shows that the arrangement of the switch 77 on the lamp housing 75 at the end facing away from the guide plate 11 is advantageous, as the user P can activate the illumination element 71 at a distance from the cutting area.

FIG. 8 shows a further design variant of the invention. An illumination arrangement 70 is shown, which is used on a hand-held circular saw 10 as shown in FIGS. 1-5 and can preferably be detachably attached. Reference is therefore made to the above explanations regarding the design of the hand-held circular saw 10.

As FIG. 8 shows, the illumination arrangement 70 has a lamp housing 75, which bears at least one protruding form-fitting element 73. The protective cover 24, preferably the lateral casing 24.6, has one or more attachment mounts 24.9, which can be formed in particular as apertures. To attach the lamp housing 75, the form-fitting element 73 engages with this attachment mount 24.9. The form-fitting element 73 and the attachment mount 24.9 preferably form a detachable connection such that a user P can optionally attach the illumination arrangement 70.

Preferably, the attachment mount 24.9 and the form-fitting element 73 form a snap-in connection that simplifies assembly and disassembly.

As FIG. 8 shows, the form-fitting element 73 may have a contact surface 72, which prevents the lamp housing 75 from being displaced in the direction of the plane formed by the outer face of the lateral casing 24.6.

FIG. 9 shows a further exemplary embodiment of the invention that can be used on a hand-held circular saw 10 as shown in FIGS. 1-5. To avoid repetition, please refer to the above explanations on the design of the hand-held circular saw 10.

As illustrated in the diagram, a cover 78 is disposed inside the chip-guiding space 24.11. This separates the light-guiding area 24.13 from the dust-conveying area of the chip-guiding space 24.11, at least sectionally. Preferably, the cover 78 also separates the illumination element 71 and in particular the entire illumination arrangement 70 from the chip-guiding space 24.11. As a result, the illumination element 71, too, is disposed in a protected manner outside the chip-guiding space 24.11.

The drawing shows that the cover 78 may be attached to the inner face of the lateral casing 24.6.

FIG. 9 illustrates that the illumination element 71 emits its light through the light-guiding area 24.13 encompassed by the cover 78. The protective cover 24 has a light passage 24.10, which is preferably formed as an aperture on the limiting element 24.7. Through this light passage 24.10, the light of the illumination element 71 shines into the area of the outside of the protective cover 24, and is preferably directed into the illumination area L2 and/or into the illumination area L1 to generate light on the top face of a workpiece 45.

In the variant of the invention described above, the illumination arrangement 70 is disposed and oriented such that the light emitted by the illumination element 71 is predominantly emitted in the feed direction V of the hand-held circular saw 10. The light emitted by the illumination element 71 extends at least sectionally, preferably completely, in a light-guiding area 24.13, which is separated from the dust-conveying area of the chip-guiding space 24.11. The illumination arrangement 70 holds the illumination element 71 behind the cutting area in the feed direction.

1-18. (canceled)

19. A hand-held circular saw, comprising:
a saw-blade holder configured to mount a saw blade;
a drive assembly configured to rotate the saw blade about a drive axis;
a protective cover encompassing a chip-guiding space and forming a saw-blade-mounting area inside the protective cover, the protective cover being configured to receive the saw blade in a working position, the protective cover including a lateral casing delimiting the chip-guiding space at an end facing away from the drive assembly; and
an illumination arrangement including at least one illumination element configured to at least partially illuminate a cutting area of the hand-held circular saw, the illumination element being disposed behind the saw-blade-mounting area and/or the cutting area relative to a feed direction of the hand-held circular saw, the illumination arrangement being disposed and oriented such that a light emitted by the illumination element is predominantly emitted in the feed direction of the hand-held circular saw, and such that the light emitted by the illumination element extends at least partially in a light-guiding area separated from a dust-conveying area of the chip-guiding space.

20. The hand-held circular saw of claim 19, wherein:
the illumination element illuminates the cutting area of the hand-held circular saw on an outside of the lateral casing.

21. The hand-held circular saw of claim 20, wherein:
the protective cover includes on an outer face facing away from the chip-guiding space a rear area marking identifying a rear end of the cutting area relative to the feed direction;
the protective cover includes on the outer face facing away from the chip-guiding space a front area marking identifying a front end of the cutting area relative to the feed direction; and
the light emitted by the illumination element illuminates at least a partial area between the rear area marking and the front area marking.

22. The hand-held circular saw of claim 21, wherein:
the light emitted by the illumination element illuminates the entire area between the rear area marking and the front area marking.

23. The hand-held circular saw of claim 19, further comprising:
a lamp support configured to hold the illumination element in an area of an outer face of the protective cover facing away from the chip-guiding space.

24. The hand-held circular saw of claim 23, wherein:
the lamp support includes a locating arrangement to which the illumination element is interchangeably coupled.

25. The hand-held circular saw of claim 23, wherein the lamp support includes:
a bearing element;
a securing piece coupling the bearing element to the protective cover;
a counter-bearing element movably connected to the bearing element; and
wherein the illumination element is coupled to the counter-bearing element such that the bearing element and the counter-bearing element form an adjustable bearing configured to adjust a position of the illumination element relative to the protective cover.

26. The hand-held circular saw of claim 19, wherein:
the protective cover includes a suction connection including a connection fitting behind the saw-blade-mounting area relative to the feed direction; and
the hand-held circular saw further includes a connection arrangement attached to the connection fitting, the connection arrangement including a connecting element to which a lamp support configured to hold the illumination arrangement is attached.

27. The hand-held circular saw of claim 26, wherein:
the connection arrangement includes a duct section for chip removal;
the connecting element is mounted on the duct section; and
the connection arrangement further includes a support connected to the connecting element and spaced apart from the duct section, the support including an attachment mount configured to be coupled to the lamp support.

28. The hand-held circular saw of claim 19, wherein:
the illumination arrangement is mounted with at least one rotational degree of freedom relative to the protective cover.

29. The hand-held circular saw of claim 19, further comprising:
a guide plate; and
a rear miter bearing disposed behind the saw-blade-mounting area relative to the feed direction, the drive assembly being swivel-coupled to the guide plate by the rear miter bearing for setting a miter angle, the rear miter bearing including a stationary bearing piece and a movable bearing piece, the stationary bearing piece being coupled to the guide plate and the movable bearing piece being coupled to the drive assembly;
wherein the illumination element is attached either to the stationary bearing piece or to the movable bearing piece.

30. The hand-held circular saw of claim 29, wherein:
the lateral casing of the protective cover includes a limiting element at a free end facing the guide plate, the limiting element including an angled outer limiting surface; and
the illumination element is disposed such that the light emitted by the illumination element is emitted in the feed direction along the limiting element.

31. The hand-held circular saw of claim 19, wherein:
the illumination arrangement includes a lamp housing which accommodates the illumination element, the lamp housing including a fastening section configured to be attached to a lamp support disposed on the protective cover.

32. The hand-held circular saw of claim 31, wherein:
the lamp housing is interchangeably connected to the lamp support by a magnetic connection.

33. The hand-held circular saw of claim 32, wherein:
the magnetic connection includes a ferrous part and a magnetic part; and
the protective cover separates the ferrous part from the magnetic part.

34. The hand-held circular saw of claim 31, wherein:
the illumination arrangement includes an electrical switch mounted on an area of the lamp housing facing away from a guide plate of the hand-held circular saw.

35. The hand-held circular saw of claim 31, wherein:
the illumination element is mounted on an end area of the lamp housing nearest a guide plate of the hand-held circular saw and laterally next to the lateral casing of the protective cover.

36. The hand-held circular saw of claim 19, further comprising:
a further cover disposed inside the chip-guiding space and at least partially separating the light-guiding area from the dust-conveying area of the chip-guiding space.

37. The hand-held circular saw of claim 19, wherein:
the lateral casing of the protective cover includes a lower free end in a form of a bend directed inwards in a direction of the chip-guiding space, and the lateral casing includes a light passage through which light of the illumination element is guided, the light passage being at least partially formed adjacent the lower free end of the lateral casing.

38. The hand-held circular saw of claim 19, wherein:
the lateral casing of the protective cover includes at least one attachment mount to which the illumination arrangement is attached, the attachment mount being formed as an aperture or a recess in the protective cover.
